(19) United States
(12) Patent Application Publication
(10) Pub. No.: US 2004/0100378 A1
(43) Pub. Date: May 27, 2004

(54) Device for safeguarding transports

(76) Inventor: Wilhelm Hollnagel, E-Malaga (ES)

Correspondence Address: RANKIN, HILL, PORTER & CLARK LLP, 4080 ERIE STREET, WILLOUGHBY, OH, 44094-7836, US

(21) Appl. No.: 10/276,853

(22) PCT Filed: May 22, 2001
(86) PCT No.: PCT/CH01/00312

(30) Foreign Application Priority Data
May 22, 2000 (CH) 1025/00

(51) Int. Cl. G08B 1/08

(52) U.S. Cl. 340/539.17; 340/425.5

(57) ABSTRACT

The device serves for safeguarding transports with a transport vehicle by alerting a head office in the case of an abnormal occurrence. It comprises a cargo space monitoring apparatus to be incorporated in the cargo space with a control apparatus for acquiring and processing data and with a telecommunication means for transmitting information signals and/or alarm signals leaving the control apparatus to a monitoring apparatus located in the head office. The cargo space monitoring apparatus further has at its disposal a locating means independent of the travelling data, for example a GPS receiver. It permits an alerting of the head office and a locating of the cargo when the driver is missing.

The invention relates to a device for safeguarding transports with a transport vehicle.

Long-distance transport is generally safeguarded in that one maintains a radio or mobile telephone link between the long-distance driver and a head office. In the case of an emergency situation, for example with a robbery, the driver raises the alarm if he is in a position to do this. The head office subsequently contacts the police. In spite of the possibility of an immediate calling of the police, robberies are however unfortunately often successful, cost many lives and create immense material damage. If also the driver and sometimes the vehicle are found then the goods may rarely or never be recovered. A reason for this is the fact that the driver often does not have the opportunity of activating the alarm. Even if an alerting is effected then mostly before the police arrive the goods have been transported away without problem.

It is therefore the object of the present invention to specify a device for safeguarding transport which does not have the disadvantages of existing devices, and which in particular permits an alerting even if the driver himself is not in the position of activating such an alarm, and which safeguards the goods of transport independently of the condition of the driver.

This object is achieved by the invention defined in the patent claims.

A vehicle to be safeguarded by the invention has a driver's cabin as well as at least one cargo space. The device is essentially characterized by a monitoring apparatus which is to be installed in the cargo space. Thus the alerting of the head office and accordingly a locating of the cargo may be effected independently of the driver and driver's cabin.

Preferably the monitoring apparatus is equipped with a locating system, for example a GPS receiver. The monitoring apparatus then in the case of an alarm and/or at regular intervals during the whole transport may transmit positioning signals to the head office. This office is thus informed of the position of the cargo in the case that it is required, or continuously. There also results the possibility of the head office itself being active, without it being alerted, if the route of the cargo deviates from a predetermined route. It may also be the case of a predetermined route being stored in the monitoring apparatus and the alerting and deactivation of the vehicle being effected if the actual location of the cargo differs from the route outside a predetermnined tolerance.

The cargo space monitoring apparatus in the above context is autonomous, that is to say it permits alarm notification and further information transmission without the driver having to do anything or a functioning of any appartatus in the driver's cabin being required. In order to further accentuate this autonomy, the cargo space monitoring apparatus advantageously has a current supply means which when required ensures a supply with electrical energy independenly of the vehicle. Such current supply means may for example be a battery which in the normal operation of the vehicle is charged via the current supply of the vehicle.

Preferably the device comprises two vehicle-based monitoring apparatus, specifically additionally to the cargo space monitoring apparatus a monitoring apparatus in the driver's cabin. These two monitoring apparatus are in communicating connection with one another as well as each individually with the monitoring apparatus of the head office. The driver's cabin monitoring apparatus may for example comprise means for identifying the driver. Such means for identifying the driver may have the setting-up of an electronic signature whilst entering a PIN code and/or an electronic fingerprint as well as a presence signal. For example such means for the identification of the driver may also comprise the reading-in of a thermal fingerprint. The cargo space monitoring apparatus may then be programmed such that it emits an alarm notice to the head office immediately if an attempt to drive away has been made without an identification previously having been successfully effected. It may furthermore also be installed in the vehicle such that it may intervene in the vehicle electronics and only permit further travel when a successful identification of the driver has been effected.

The monitoring apparatus in the cargo space may comprise means with which one may ascertain if a present cargo has been separated from the cargo space and/or if the cargo space has separated from the driver's cabin. Thus for example there may exist an electrical contact or a radio contact between the driver's cabin carrier or the cargo carrier or the cargo, or a contact between the cargo space monitoring apparatus or at least one element contacted by this or fixedly connected to the cargo or (in each case) a part of the cargo on the one hand and the chassis on the other hand. Such a connection is checked constantly or at short intervals with regard to its existence. An interruption of the connection is an abnormal occurrence, and an (alarm) signal may be transmitted by one of the monitoring apparatus to the head office. A simple example for realising such a connection is a conducting loop which is led through the cargo. This may for example further be provided with a certain electrical resistance so that a predetermined current flows. In this manner one may ensure that the monitoring function of the conducting loop is not rendered ineffective by a short circuit at the output and input of the loop. Alternatively to a predetermined electrical resistance, a fixed oscillation frequency of an element predetermined with the cargo, for example an LC circuit or an oscillation quartz may also serve for the control. Of course a cable-free connection to the monitoring apparatus and the element connected to the cargo is conceivable. A removal of the cargo from the cargo space would effect an interruption, this on account of the shielding of electromagnetic waves by the cargo space or at least on account of an increased distance of the element from the monitoring apparatus. If several elements independent of and connected to the various parts of the cargo are present, which for example becomes useful if the whole cargo is not loaded and/or unloaded at the same time, then for example each element may have a different characteristic frequency or a characteristic resistance.

The cargo space monitoring apparatus, an element fixedly connected to a part of the cargo or possibly a driver's cabin monitoring apparatus may possibly also have a homing transmitter. In the case of alarm this may be additionally activated and for example be homed to the SAR frequency of helicopters. Additionally to the location notification conveyed to the head office, with this a location determination is possible from outside directly at the location of the critical situation.

In the following a special embodiment example of the invention is described by way of three schematic drawings. With this there are shown in

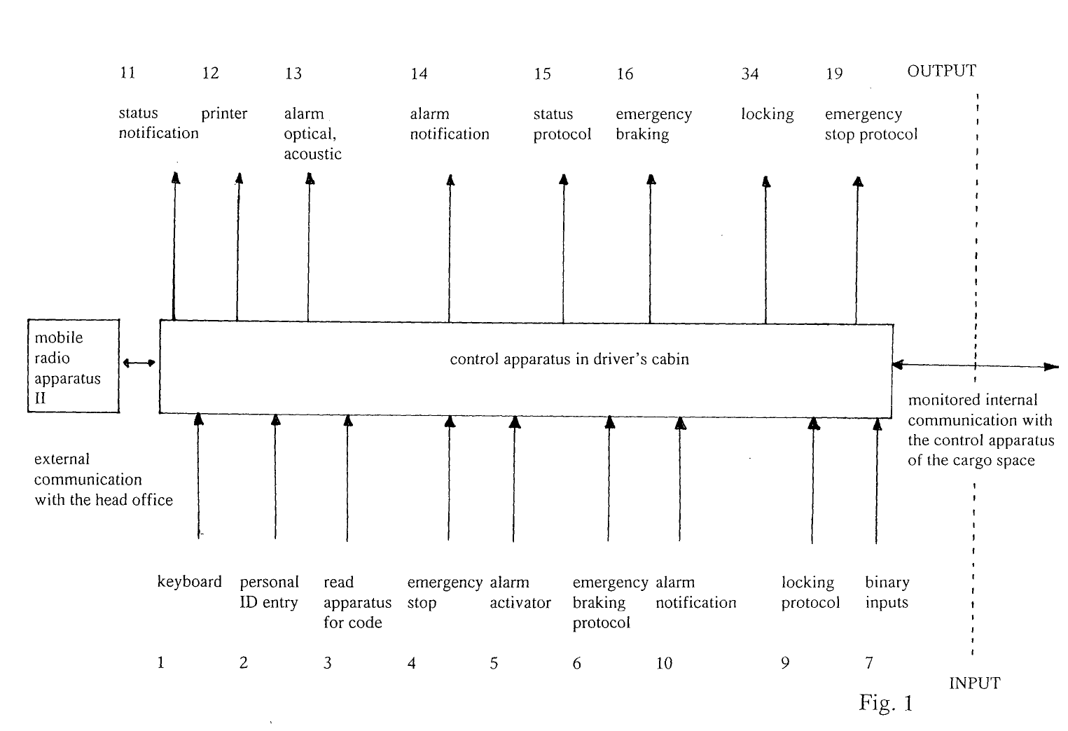

FIG. 1 a schematic drawing of the information flow for a monitoring apparatus in the driver's cabin,

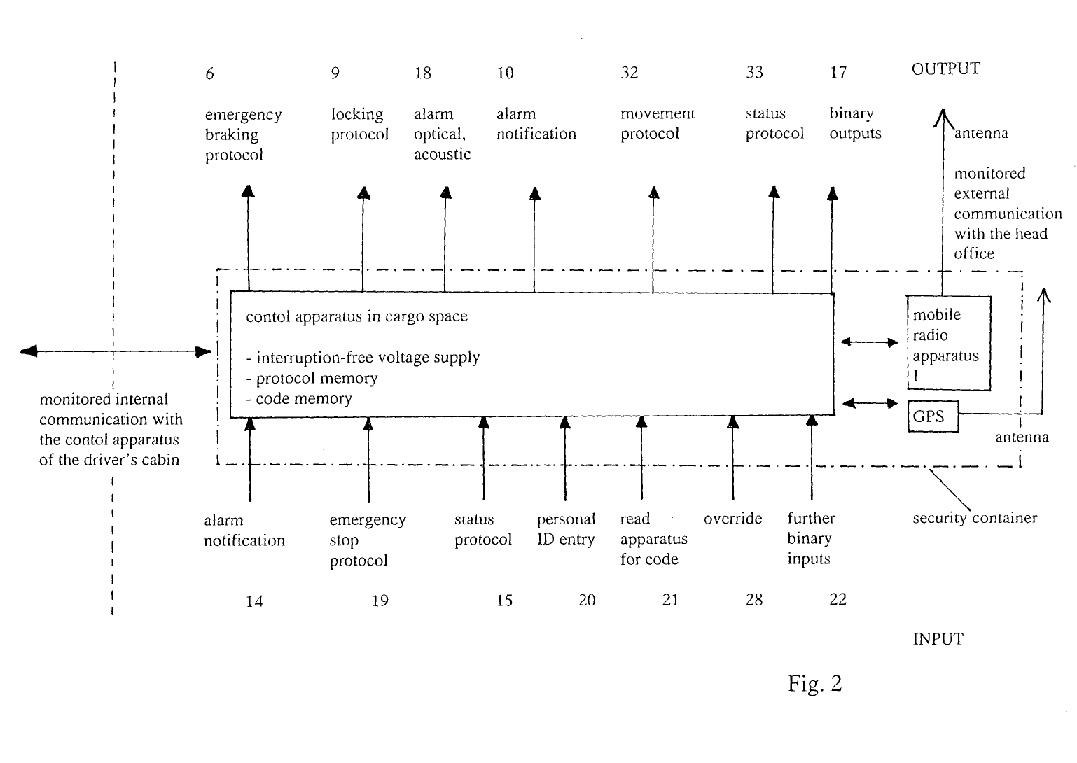

FIG. 2 a schematic drawing of the information flow for a monitoring apparatus in the cargo space,

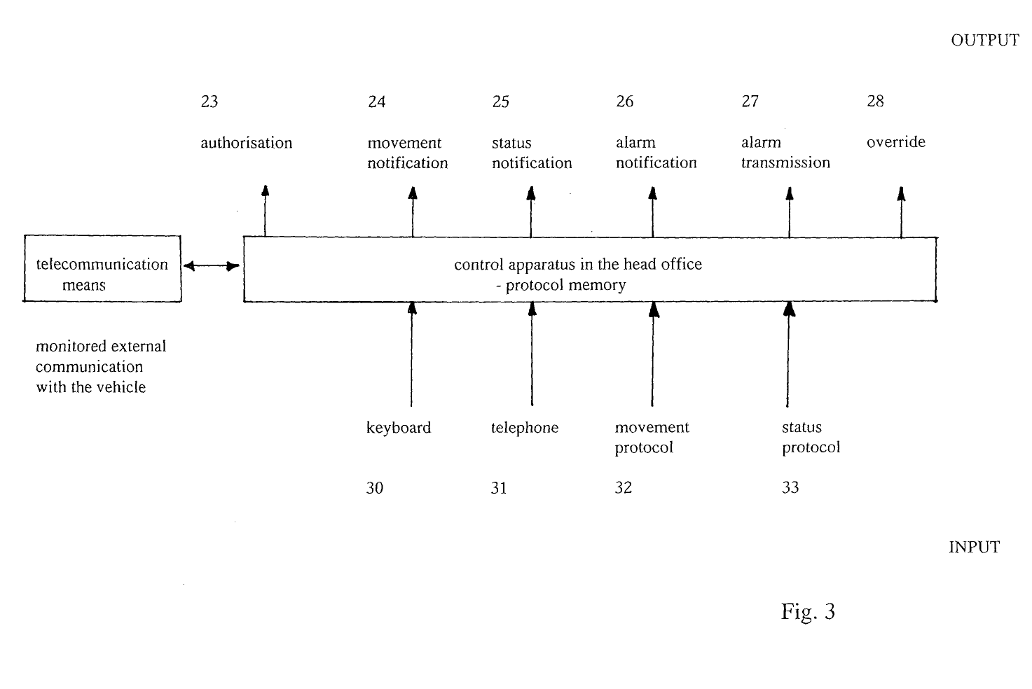

FIG. 3 a schematic drawing of the information flow for a monitoring apparatus in the head office and

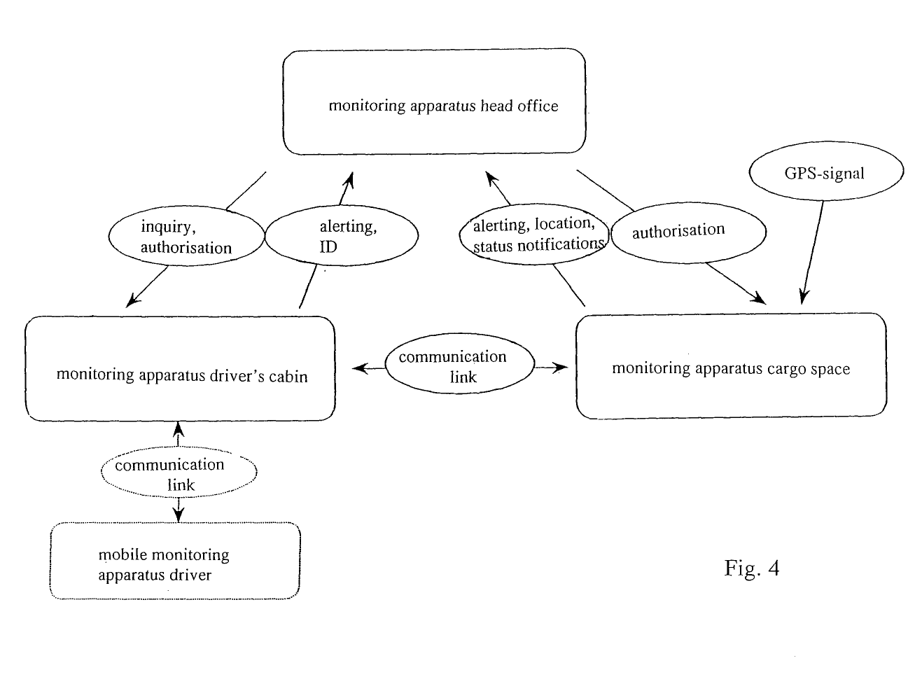

FIG. 4 a schematic drawing of the interaction between the monitoring apparatus in the driver's cabin, in the cargo space and in the head office.

As is shown in FIG. 1, the driver's cabin monitoring apparatus comprises a control apparatus shown by a rectangle in the figure as well as a mobile radio apparatus in connection with this. The mobile radio apparatus may for example be a conventional mobile telephone. It may also be a transmitter and receiver apparatus of a worldwide, wireless telephone system with satellite signal transmission, a shortwave radio apparatus or any other wireless telecommunication means. The mobile radio apparatus ensures the communication with the head office. The information which may be fed into the control apparatus (INPUT) is shown in the figure below the control apparatus. It comprises the driver actively and where required inputted information or control signals such as keyboard entries 1, an emergency stop 4 and alarm notifications 10, inputs demanded from the driver by way of input requests such as the personal ID input 2 (fingerprint) possibly also the living function of the driver as a periodic monitoring and the PIN code entry 3 as well as vehicle control signals such as protocols of an alarm activation 5, an emergency braking 6 or a locking 9. Binary inputs 7 permit the connection of additional data processing apparatus. Information or control signals (OUTPUT) transmitted further by the control apparatus contain certain status notifications 11 for the driver, optical and/or acoustic alarm displays 13 and a printer output 12, and added to this alarm notifications 14 for the cargo space monitoring apparatus, status protocols 15 with location notification and the course of movement and emergency stop protocols 19 as well as control signals for activating an emergency braking 16 or a locking 34.

The cargo space monitoring apparatus described by way of FIG. 2 has a control apparatus, a mobile radio apparatus of the type which is present in the driver's cabin as well as a GPS receiver with a connection to a GPS-antenna. The control apparatus, mobile radio apparatus and GPS receiver are arranged in a security container which is securely closed and which also contains the cargo. The security container may only be opened if an authorisation has been effected by the head office, the driver alone may not open the security container. The control apparatus is in constant communication connection with the control apparatus of the driver's cabin. If this communication link is interrupted, for example because the security container or even the cargo space has been transported away, the control apparatus automatically activates an alarm notification. Furthermore a much smaller security container is indeed also conceivable which only includes the control apparatus, mobile radio apparatus, GPS receiver and possibly further electronic apparatus and does not contain the cargo. Such a smaller container may be rigidly connected to a part of the cargo or to a closed cargo space and for example be welded into a base of a box or likewise in a manner which is hardly visible. It is furthermore also conceivable for another event to activate an automatic alarm notification additionally to or in place of an interruption of the communication link, for example the interruption of a cable contact between the chassis of the vehicle and a part of the cargo.

In FIG. 2 the possible INPUT and OUTPUT channels of the control apparatus in the cargo space are shown analogously to FIG. 1. Apart from the data transmitted by the driver's cabin monitoring apparatus such as alarm notifications 14, emergency stop protocols 19 and status protocols 15, in the cargo space monitoring apparatus there may also be provided the possibility of a personal ID entry 20 with a PIN code entry 21 by the driver, and for example additionally to an authorisation by the head office for unloading the cargo space. Furthermore a predetermined sequence, for example the blocking the cargo space, may be cancelled from the head office, which for example may be required with an accident (override function 28). Information and signals leaving the control apparatus comprise the signals going to the driver's cabin monitoring apparatus—emergency braking protocol 6, locking protocol 9 and alarm notification 10, an optical and/or acoustic alarm display in the cargo space as well as movement and status protocols 32 and 33 respectively transmitted to the head office. An information exchange with further sensors, safety and monitor circuits, control apparatus, data processing apparatus, etc. may take place via binary inputs and outputs 22 and 17 respectively.

The monitoring apparatus of the head office finally comprises a control apparatus as well as a telecommunication means connected to this, for communication with the vehicle as well as in any case further means, see FIG. 3. The input channels of course comprise operator tools such as a keyboard 30 and telephone 31 but also the information movement protocol 32 and status protocol 33 transmitted by the cargo space monitoring apparatus as well as where appropriate further signals transmitted by the driver's cabin monitoring apparatus or by the cargo space monitoring apparatus, in particular alarm signals. Amongst others movement notifications 24, status notifications 25 and alarm notifications 26 are outputted on displays in the head office and authorisation signals 23 as well as an override signal 28 to the vehicle. Additionally for example there is provided a further transmission of the alarm to police stations, which is effected automatically, and other means depending on the case. As such for example an automatic fax letter in the local language may be dispatched to the closest police operating station where appropriate with position details and/or homing frequency.

FIG. 4 shows an overview of the interaction between the monitoring apparatus in the driver's cabin, cargo space and head office, wherein only the most important interactions are shown. For a more detailed description of the flow of information the previous figures and their description are referred to. In FIG. 4 there is also additionally shown an optional monitoring apparatus for the driver (dot-dashed). Such an optional apparatus is for example in constant communication link to the driver's cabin monitoring apparatus and to a certain extent represents an extension of this. By way of such a driver monitoring apparatus the driver for example may be informed on the status of the vehicle and/or be warned in the case of an abnormal occurrence when he is not located in the vehicle. A driver monitoring apparatus may for example be portable on the belt and have at its disposal means for transmitting an acoustic alarm signal.

The functioning manner of the device is as follows:

The cargo space of the vehicle after loading is secured by the device. This is effected for example in that the driver installs the device by way of a keyboard input. After initialising the device the driver does not at all have the possibility of canceling this without the intervention of the head office. After initialisation the monitoring apparatus in the cargo space transmits a status protocol and a movement protocol to the head office, said protocols being constantly activated, e.g. in preprogrammed time intervals. The monitoring apparatus on the one hand records the data for these protocols by way of the above described input channels, on the other hand by way of the satellite navigation system. Furthermore the control apparatus in the driver's cabin and in the cargo space are configured such that before each start of the motor as well each opening of the cargo space the driver is requested to identify himself 2, 3, 20, 21. An alarm together with a locking/drive-away blocking is activated if the following abnormal occurrence occurs:

an attempt (or several successive attempts) of a driver identification by fingerprint 2 and PIN code input 3 fails,

the communication between the monitoring apparatus of the driver's cabin and the cargo space is interrupted,

the connection (via radio or cable) between the cargo space monitoring apparatus and an element fixedly connected to the cargo is interrupted

the driver manually activates an alarm 5.

An alarm for example lies in an automatic notification to the head office with an acoustic and/or optical alarm signal in the driver's cabin and in the cargo space 13 and 18 respectively. In response to an alarm the driver for example is called from the head office and asked for a previously agreed code. If he gives the all-clear by way of giving the correct code, the head office cancels the locking/drive-away blocking. Otherwise the alarm is immediately transmitted further to the police etc. 27. At the same time the police are informed of the exact location of the cargo which is transmitted to the head office via the movement protocol 32. This information when required is continuously updated. If the cargo space monitoring apparatus or an element connected to the cargo further has a homing transmitter, this of course is advantageously used for homing in on the cargo, for example by helicopter.

The head office may itself activate an alarm. This for example happens when it is ascertained that the cargo is not located on a route which has previously been fixed.

Additionally to the previously briefly described alarm mechanism a further information exchange may also take place by way of the device according to the invention. The driver for example may be assisted immediately if an emergency braking has been effected on which the head office is immediately notified via the status protocol.

Finally it is yet to be mentioned that the previously described device is of course not the only embodiment form of the invention. For example one may not exclude the driver's cabin monitoring apparatus not having any transmitter, i.e. no mobile radio apparatus of its own. All information leaving the driver's cabin is firstly transmitted to the cargo space monitoring apparatus and where appropriate is only subsequently transmitted by its mobile radio apparatus. One may go even further and completely omit the driver's cabin monitoring apparatus. In such a case an automatic alarm is for example activated if an electrical contact between the vehicle chassis and the cargo space control apparatus or a probe having a communication link to this is interrupted.

1. A device for safeguarding transports with a transport vehicle comprising a driver's cabin and at least one cargo space, by alerting a head office with an abnormal occurrence, characterised by a cargo space monitoring apparatus to be incorporated in the cargo space with a control apparatus for acquiring and processing data and with a telecommunication means for transmitting information signals and/or alarm signals leaving the control apparatus to a monitoring apparatus located in the head office.

2. A device according to claim 1, characterised in that the cargo space monitoring apparatus has a current supply means which may function independently of the vehicle.

3. A device according to claim 1 or 2, characterised in that the cargo space monitoring apparatus has a locating means independent of travel data, for example a GPS receiver.

4. A device according to claim 3, characterised in that the cargo space monitoring apparatus may be configured such that it continuously or at regular time intervals transmits its position determined with the locating means to the head office.

5. A device according to one of the preceding claims, characterised in that there are present means for maintaining a connection between the cargo space monitoring apparatus and at least one part of the cargo and/or at least one element fixedly connected to the cargo, with which means also a separation of this connection may be detected and that the cargo space monitoring apparatus may be configured such that on detection of the separation of this connection it transmits an alarm signal to the monitoring apparatus of the head office.

6. A device according to one of the preceding claims, characterised by a driver's cabin monitoring apparatus to be incorporated in the driver's cabin with an instrument for producing an electronic signature, as well as by communication means for maintaining a communication link between the cargo space monitoring apparatus and the driver's cabin monitoring apparatus.

7. A device according to claim 6, characterised in that the instrument for producing the electronic signature comprises a first means which registers a body feature and prepares data from this, and preferably a second means which registers the presence of a person from which one has recorded the body feature.

8. A device according to claim 6 or 7, characterised in that the driver's cabin monitoring apparatus has a telecommunication means for transmitting information signals and/or alarm signals leaving the control apparatus to the monitoring apparatus located in the head office.

9. A device according to one of the claims 6 to 8, characterised in that the cargo space monitoring apparatus and/or the driver's cabin monitoring apparatus may be configured such that on separation of the communication link between the cargo space monitoring apparatus and the driver's cabin monitoring apparatus it transmits an alarm signal to the monitoring apparatus of the head office.

10. A device according to one of the preceding claims, characterised by a homing transmitter integrated in the cargo space monitoring apparatus or fixedly connectable to the cargo or a part of the cargo.

11. A means for safeguarding transports with a transport vehicle comprising a driver's cabin and at least one cargo space, by alerting a head office, characterised by a cargo space monitoring apparatus to be incorporated in the cargo space, with a control apparatus for acquiring and processing data, with a communication means for transmitting and/or receiving information signals and/or alarm signals, said signals leaving the control apparatus or coming in, and with a locating means independent of the travelling data, for example a GPS receiver, as well as by a monitoring apparatus to be installed in the head office, with a communication means for transmitting and/or receiving information signals and/or alarm signals to or from the cargo space monitoring apparatus.

12. A means according to claim 11, characterised by a driver's cabin monitoring apparatus to be incorporated in the driver's cabin, by communication means for maintaining a communication link between the cargo space monitoring apparatus and the driver's cabin monitoring apparatus as well as preferably by communication means for exchange of information signals and/or alarm signals between the monitoring appartus of the head office and the driver's cabin monitoring apparatus.

13. A method for alerting a head office with an abnormal occurence with a transport with a transport vehicle comprising a driver's cabin and at least one cargo space, characterised in that a cargo space monitoring apparatus to be incorporated in the cargo space, with a locating means operating independently of the travelling data, for example a GPS receiver, and with a telecommunication means, transmits an alarm signal and its position to a monitoring apparatus located in the head office in the case of an abnormal occurrrence.

14. A method according to claim 13, characterised in that an automatic transmission of an alarm signal to a police station located in the vicinity of the cargo space monitoring apparatus is made by the head office on arrival of an alarm signal.
